(19) United States
(12) Patent Application Publication
(10) Pub. No.: US 2006/0249950 A1
(43) Pub. Date: Nov. 9, 2006

(54) Scratch-off coating area for application of indicia by users of consumable products

(76) Inventors: Lois P. Kenney, Fullerton, CA (US); James M. Kenney, Fullerton, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/124,526

(22) Filed: May 9, 2005

(51) Int. Cl. B42D 15/00

(52) U.S. Cl. 283/81

(57) ABSTRACT

An area on the label of a bottle of water/soda or can of soda/beer has a coating providing the ability to scratch one's personal identification onto the label with a fingernail, e.g. 1″ or 1½″ square area on the label. Many or most of the labels are pre-made, pre-printed labels or which may be printed on line in the packaging operation. The area designated for personal identification would be printed on the label, either a pre-made label or one printed in the packaging operation, similar to a scratch-off area which is commonly found on scratch-off lottery tickets. Of course, the present invention is not limited for use on bottles. Labels or containers having a designated area of scratch-off material could be used on a large variety of consumable products including packaged foods, beer, fast foods, tobacco products, over-the-counter drugs and vitamins and virtually any other product where it would be useful to provide user-applied indicia. An optional additional feature of the present invention comprises a removable tag protectively overlying the scratch-off coating to prevent inadvertent removal of the scratch-off material either before the product reaches the consumer or afterward.

### BACKGROUND OF THE INVENTION

1. Field of the Invention

The present invention relates to the field of personal identification labels for permitting consumers of consumable products to conveniently identify a particular product as theirs. More specifically, the invention relates to consumable product labels having a specially designated area with a “scratch-off” material coating to permit a user to conveniently place personal identifying indicia such as name initials on the label to personalize the product or to provide other useful information thereon.

2. Background of the Invention

There has been a substantial increase in recent years in the use of personal size bottles of purified water, soda, sports drinks, beer etc., especially in portable plastic containers. This increase stems from a number of factors including greater concern about tap water contamination and cross contamination from one person to another, improvements in bottle packaging and materials and larger expenditures by water, soda and drink bottling companies in advertising their products. Consequently, it is today relatively common to observe people carrying a bottle of water, soda or other drink on their person, in their purse or pocket, in their cars, backpacks, briefcases, etc. This is particularly the case in places where people gather such as in sporting events, recreational venues, social functions, gymnasiums and even business meetings and the like.

The invention permits keeping track of each person's bottle of water/soda/beer, etc. One of the problems with carrying a bottle of water/soda, especially when there are other people nearby or in close proximity, especially at work, at the gym or at a party or social gathering, is that, as soon as you put down the bottle of water/soda/beverage, you lose track of it. A substantial percentage of the bottles of water/soda/beverage are wasted, as a person loses track of it or cannot remember which bottle of water/soda/beverage was their bottle of water/soda/beverage. This is especially true when the bottle of water/soda/beverage is taken to the gym or any social function where many people are involved.

This invention prevents the loss of this waste and would more than pay for the cost of the invention. The disclosed solution comprises a blank area on the label of the bottle of water/soda/beverage which is designated for adding one's personal initial or other identification, so that it can be determined whose bottle of water/soda/beverage it is.

It also prevents potential cross contamination of colds and diseases from one person to another, particularly at sporting events, such as, basketball games or practices, where during time out periods, players or participants would replenish fluids. Each person could identify their own bottle of water/soda/beverage.

### SUMMARY OF THE INVENTION

An area on the label of a bottle of water/soda/beverage has a coating providing the ability to scratch one's personal identification onto the label with a fingernail, e.g. 1″ or 1½″ square area on the label. The bottle of water/soda is typically printed with company name, address, logo or other information required by the FTC or other government regulating body, which is printed on a label supplied to the water/soda bottle manufacturer. Many or most of the labels are pre-made, pre-printed labels or which may be pre-printed on line in the packaging operation. The area designated for personal identification would be printed on the label, either a pre-made label or one printed in the packaging operation, similar to a scratch-off area which is commonly found on scratch-off lottery tickets. The coating for the scratch-off area would be provided by the supplier of the label. Since the labels are printed by these suppliers, there would be a very minor increase in cost for adding the scratch-off coating to the label.

Someone could use a pen or pencil to add this identification to the bottle, but no area on the label is currently available on bottles of water/soda to do so, and you have to have a pen or pencil to write your identification on the bottle. This is very inconvenient and, often not practical, especially at certain functions, such as the gym or other sporting event. This invention would give a bottler of water/soda a distinct marketing advantage. Currently, the consumer sees no advantage of buying one bottle of water/soda/beverage over another bottle of water except based on price or due to advertising efforts of the supplier. This invention would differentiate a supplier of bottled water/soda/beverage over another supplier of bottled water/soda, thereby, giving that supplier a sales advantage over the other and thereby potentially increasing sales over the competition.

Of course, the present invention is not limited for use on bottles. Labels or containers having a designated area of scratch-off material could be used on a large variety of consumable products including packaged foods, fast foods, tobacco products, beer, over-the-counter drugs and vitamins and virtually any other product where it would be useful to provide user-applied indicia.

An optional additional feature of the present invention comprises a removable tag protectively overlying the scratch-off coating to prevent inadvertent removal of the scratch-off material either before the product reaches the consumer or afterward.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional front view of a typical commercial drinking water bottle bearing a label according to a preferred embodiment;

FIG. 2 is a rear view of the bottle and label of FIG. 1;

FIG. 3 is a cross-sectional view of the bottle and label of FIG. 2 including the area of scratch-off material thereon’

FIG. 4 illustrates the process of a user of the preferred embodiment placing identifying indicia on the label;

FIG. 5 shows the result of the process depicted in FIG. 4 and an optional protective tag of the preferred embodiment; and

FIG. 6 is a cross-sectional view taken along lines 6-6 of FIG. 5.

### DETAILED DESCRIPTION OF A PREFERRED EMBODIMENT

Referring to the accompanying drawings, it will be seen that the illustrated embodiment 10 is employed on a typical, commercially available drinking water bottle 12 which is often made of a transparent plastic and provides a threaded cap 14 having a built-in moveable dispenser 16 selectively exposing an orifice 18. A label 20 usually provides the trademark of the bottler as well as required information such as nutrition information, location of manufacturer, etc. The label 20 may also have a UPC code 25 and other information, none of which is particularly relevant to the present invention.

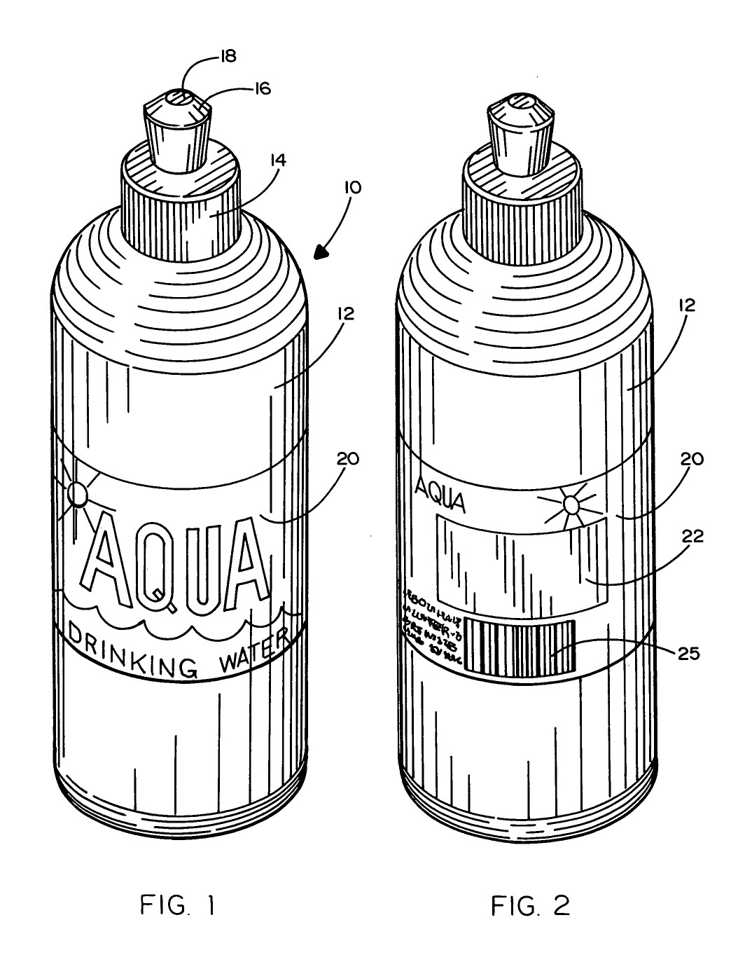

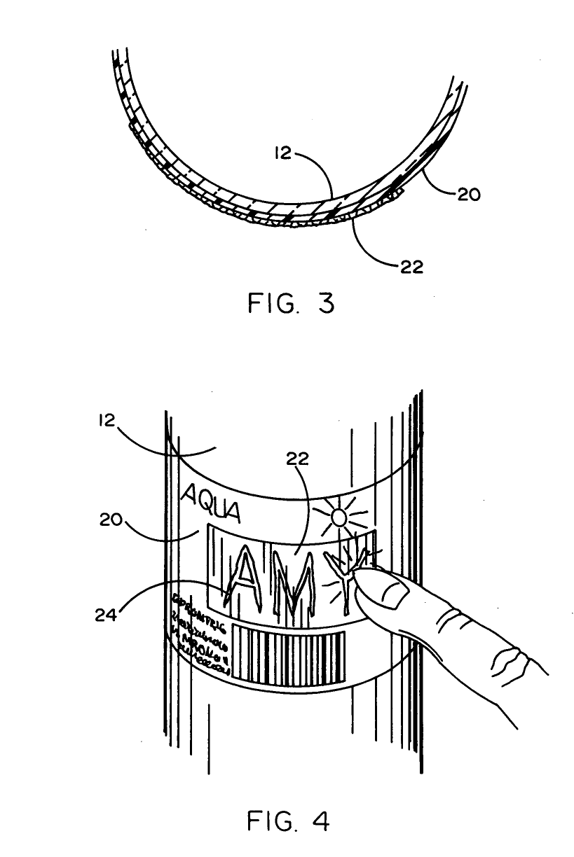

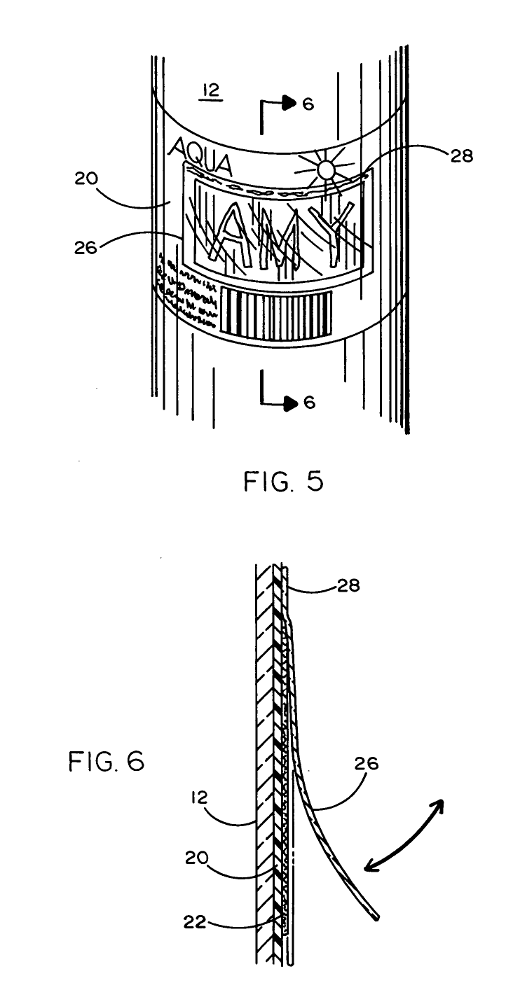

The inventive feature hereof relates primarily to a designated area 22, shown for example in FIGS. 2-6, and which is coated with a scratch-off material. This coating is preferably completely blank and fully intact when a purchaser of the product receives the item from a retailer. Then, as shown best in FIGS. 4 and 5, the purchaser selectively removes portions of the coating such as by use of a fingernail to carefully scrape away some of the coating, to create desired indicia 24. In the illustrated example, the purchaser or user has scratched the letters “AMY” into the coating to uniquely identify that product as belonging to AMY.

It will be understood that the inventive aspect hereof is the provision of an easily removed coating material on an otherwise standard label or packaging surface to provide a convenient way to uniquely identify possession of that particular product with indicia formed by selective removal of the coating material. The particular scratch-off material including its adherence to the underlying surface, its thickness, color and other relevant physical characteristics will be readily apparent to those of skill in the art relating to such coatings. One example of a suitable scratch-off coating is a solvent-based or water-based wax-containing ink applied to a paper or coated paper label using a flat bed or rotary silk screen process to a thickness of about 0.5 mils over a suitable barrier coating. Suitable coating materials are available from Craig Adhesives and Coatings Company of Newark, N.J. Color of the coating will depend on the label color and the nature of the product. A homogenous, opaque white, black or silver colored coating material are probably the most preferred choices, but many different colors are available.

An optional feature of the preferred embodiment is shown in FIGS. 5 and 6. More specifically, the coated area may be covered by a protective flap or tag 26 which may be adhered along a unitary margin 28 to protect the coating before retail sale and protect the identifying indicia 24 after the user scratches them into the coating. The flap or tag 26 is preferably a transparent flexible plastic or if removed by the user; it may be made of an opaque material such as paper or cardboard.

Having thus disclosed a preferred embodiment, it will now be apparent that many modifications may be made. By way of example, the scratch-off coating may be applied directly to the product or container of the product. Moreover, the nature of the product or container thereof, although primarily intended for consumables, may be virtually any commercial commodity or container thereof including for example, boxed foods, bagged foods, canned foods, consumable liquids of various kinds, tobacco products, beer pharmaceuticals, vitamins, food supplements, fast food containers and package wraps, hardware goods, dairy containers, sports drinks, juices and perishables of all kinds. Moreover, while the emphasis herein is to apply identifying indicia on the coating material, it could also be used by the user to apply other information such as dates, nature of contents (such as paint color on paint cans) and the like.

Accordingly, the scope hereof should be construed in its broadest sense limited only by the appended claims and their equivalents.

I claim:

1. A label for attachment to a container of a consumable product, the label comprising:
a selected area designated for use by a consumer of a said product, said area being coated by a scratch-off material selectively removable by a consumer to enable the consumer to create identifying indicia in said designated area.

2. The label recited in claim 1 said scratch-off material being configured for selective removal by a consumer using a fingernail to create said indicia.

3. The label recited in claim 1 wherein said consumable product is taken from the group of products consisting of: bottled water, sodas, fruit juices, sports drinks, alcoholic beverages, milk, iced tea, coffee, packaged sandwiches, boxes of cookies, boxes of donuts, bags of snack foods, packages of potato chips, packages of pretzels, boxes of crackers, tobacco products including cigarettes, cigars, chewing tobacco and pipe tobacco, over-the-counter pharmaceutical products, bottles of vitamins and food supplements and packaged fast food items including hamburgers, chicken pieces and ethnic foods including pizza, burritos and tacos, sandwiches and coffee and other drinks in cups.

4. The label recited in claim 1 further comprising a removable tag protectively overlying said selected area to prevent inadvertent removal of said scratch-off material.

5. An article of manufacture comprising a scratch-off coating applied to a product or container thereof on a designated area and configured for selective removal of a portion of the coating by a purchaser of the product for creating informative indicia thereof after purchasing the product.

6. The scratch-off coating recited in claim 5 further comprising a removable protective flap overlying said designated area for protecting said coating.

7. The scratch-off coating recited in claim 6 wherein said flap is transparent.

8. The scratch-off coating recited in claim 6 wherein said flap is adhered to said product or container along a unitary margin of said flap to permit selective exposure of said designated area to access said coating.

9. An article of manufacture comprising a scratch-off coating applied to a designated area of a label for use on a product and configured for selective removal of a portion of the coating by a purchaser of the product for creating informative indicia thereon after purchasing the product.

10. The scratch-off coating recited in claim 9 further comprising a removable protective flap overlying said designated area for protecting said coating.

11. The scratch-off coating recited in claim 10 wherein said flap is transparent.

12. The scratch-off coating recited in claim 10 wherein said flap is adhered to said label along a unitary margin of said flap to permit selective exposure of said designated area to access said coating.
